(19) United States
(12) Patent Application Publication
(10) Pub. No.: US 2007/0268986 A1
(43) Pub. Date: Nov. 22, 2007

(54) Wireless communication device

(76) Inventor: Tadashi Morita, Osaka (JP)

Correspondence Address: MCDERMOTT WILL & EMERY LLP, 600 13TH STREET, NW, WASHINGTON, DC, 20005-3096, US

(21) Appl. No.: 11/798,631

(22) Filed: May 15, 2007

(30) Foreign Application Priority Data
May 15, 2006 (JP) 2006-135092

(51) Int. Cl. H04L 27/00

(52) U.S. Cl. 375/295

(57) ABSTRACT

In a communication method such as IEEE 802.11a that uses a short training sequence, a wireless receiver must complete AGC, synchronization establishment and the like in the short training sequence period, and perform AFC is the remaining short training sequence period. With the present invention, a wireless transmitter varies the length of the training sequence in accordance with a factor such as a communication frame or a transmission destination. For instance, when a transmission rate is greater than a predetermined threshold value, a training sequence that includes a greater number of training symbols than a predetermined number is transmitted. The wireless receiver is able to allocate the training sequence that is longer than normal to AGC, synchronization establishment and the like, and therefore high performance communication can be realized.

### BACKGROUND OF THE INVENTION

(1) Field of the Invention

The present invention relates to a wireless communication method that uses a very short training sequence, such as IEEE 802.11a.

(2) Description of the Related Art

In addition to making computer networks wireless, wireless communication defined by standards such as IEEE 802.11a (see IEEE P802.11a/D7.0, July 1999) is developing as an access function used in various fields such as mobile telephones, home AV devices and game machines.

With wireless communication according to IEEE 802.11a, a transmitter sends a training sequence that includes 10 short training symbols. The length of the training sequence is 16 μs. A receiver must execute AGC (automatic gain control), synchronization establishment, and AFC (automatic frequency control) during the reception of the training sequence.

However, with a communication method such as IEEE 802.11a in which the training sequence is very short, the receiver may not be able to allocate sufficient length in the limited training sequence to each of AGC, synchronization establishment, and AFC in order to finish each of these processes. This results in each of the processes having to be repeated until synchronization establishment etc. are complete, thus causing reduced communication performance, and may even prevent communication from being performed because synchronization establishment and the like are not completed.

### SUMMARY OF THE INVENTION

In view of the stated problem, the present invention has an object of providing a wireless communication device able to perform wireless communication without a reduction in communication performance.

In order to achieve the stated object, the present invention is a wireless communication device that performs wireless communication with a counterpart wireless communication device, characterized by: transmitting, attached to a communication frame, a training sequence that includes training symbols of a fixed pattern, the training symbols being greater in number than a predetermined number as necessary. Furthermore, the wireless communication device includes: a judgment unit operable to judge whether or not to make a length of the training sequence longer than a normal training sequence length; an a transmission unit operable to, when it is judged that the length of the training sequence is to be made longer than the normal training sequence length, transmit the training sequence that includes the training symbols greater in number than the predetermined number.

According to the stated structure, the wireless communication device transmits a communication frame with a training sequence attached thereto that, as necessary, includes training symbols greater in number than a predetermined number. Therefore, a counterpart wireless communication device that receives the communication frame is able to allocate a sufficiently long training sequence to AGC, synchronization establishment, and AFC. This avoids a situation in which these processes must be performed repeatedly until synchronization establishment and the like are complete, and in which communication cannot be performed due to synchronization establishment and the like failing to be completed. Therefore, the present invention has the superior effect of being able to prevent a reduction in communication performance.

Here, the judgment unit may judge whether or not a transmission rate is greater than a predetermined threshold value, and the transmission unit may transmit the training sequence that includes the training symbols greater in number than the predetermined number, when it is judged that the transmission rate is greater than the predetermined threshold value.

According to the stated structure, when the transmission rate is judged to be greater than the predetermined threshold value, the training sequence including a greater number of training symbols than the predetermined number is transmitted, and therefore a reduction in communication performance corresponding to the transmission rate can be avoided in the counterpart wireless communication device.

Here, the judgment unit may judge whether or not a data length of a communication frame is greater than a predetermined threshold value, and the transmission unit may transmit the training sequence that includes the training symbols greater in number than the predetermined number, when it is judged that the data length of the communication frame is greater than the predetermined threshold value.

According to the stated structure, when the data length of the communication frame is judged to be greater than a predetermined length, the training sequence including a greater number of training symbols than the predetermined number is transmitted, and therefore a reduction in communication performance corresponding to the data length can be avoided in the counterpart wireless communication device.

Here, the judgment unit may judge whether or not a communication frame is a retransmission frame, and the transmission unit may transmit the training sequence that includes the training symbols greater in number than the predetermined number, when it is judged that the communication frame is a retransmission frame.

According to the stated structure, when the communication frame is judged to be a retransmission frame, the training sequence including a greater number of training symbols than the predetermined number is transmitted, and therefore a reduction in communication performance in the counterpart wireless communication device can be avoided when transmitting a retransmission frame.

Here, the judgment unit may judge whether or not a communication frame is a control frame pertaining to communication control, and the transmission unit may transmit the training sequence that includes the training symbols greater in number than the predetermined number, when it is judged that the communication frame is a control frame.

According to the stated structure, when the communication frame is judged to be a control frame, the training sequence including a greater number of training symbols than the predetermined number is transmitted, and therefore a reduction in communication performance in the counterpart wireless communication device can be avoided when transmitting a control frame.

Here, the judgment unit may judge whether or not a communication frame is a multicast frame, and the transmission unit may transmit the training sequence that includes the training symbols greater in number than the predetermined number, when it is judged that the communication frame is a multicast frame.

According to the stated structure, when the communication frame is judged to be a multicast frame, the training sequence including a greater number of training symbols than the predetermined number is transmitted, and therefore a reduction in communication performance in the counterpart wireless communication device can be avoided when transmitting a multicast frame.

Here, the judgment unit may judge whether or not the counterpart wireless communication device performs bandwidth compensation, and the transmission unit may transmit the training sequence that includes the training symbols greater in number than the predetermined number, when it is judged that the counterpart wireless communication device performs bandwidth compensation.

According to the stated structure, when it is judged that the counterpart wireless communication device performs bandwidth compensation, the training sequence including a greater number of training symbols than the predetermined number is transmitted, and therefore a reduction in processing performance in the counterpart wireless communication device that performs bandwidth compensation can be avoided.

Here, the judgment unit may judge whether or not the counterpart wireless communication device performs signal detection using a certain signal detection method, and the transmission unit may transmit the training sequence that includes the training symbols greater in number than the predetermined number, when it is judged that the counterpart wireless communication device performs signal detection using the signal detection method.

According to the stated structure, when it is judged that the counterpart wireless communication device performs detection according to a specific signal detection method, the training sequence including a greater number of training symbols than the predetermined number is transmitted, and therefore a reduction in processing performance in the counterpart wireless communication device can be avoided.

Here, the wireless communication device may further include: an acquisition unit operable to acquire, from the counterpart wireless communication device, antenna method information showing whether or not the counterpart wireless communication device has a communication unit that uses an antenna diversity method, wherein the judgment unit judges, with use of the acquired antenna method information, whether or not the counterpart wireless communication device has a communication unit that uses an antenna diversity method, and the transmission unit transmits the training sequence that includes the training symbols greater in number than the predetermined number, when it is judged that the counterpart wireless communication device has a communication unit that uses an antenna diversity method.

According to the stated structure, when it is judged that the counterpart wireless communication device has a communication unit that uses an antenna diversity method, the training sequence including a greater number of training symbols than the predetermined number is transmitted, and therefore a reduction in processing performance in the counterpart wireless communication device can be avoided.

Here, the wireless communication device may further include: an acquisition unit operable to acquire, from the counterpart wireless communication device, reception power information showing reception power of the counterpart wireless communication device, wherein the judgment unit judges whether or not the reception power shown by the acquired reception power information is greater than a predetermined threshold value, and the transmission unit transmits the training sequence that includes the training symbols greater in number than the predetermined number, when it is judged that the reception power is greater than the predetermined threshold value.

According to the stated structure, when the reception power of the counterpart wireless communication device is judged to be greater than a predetermined threshold value, the training sequence including a greater number of training symbols than the predetermined number is transmitted, and therefore a reduction in processing performance in the counterpart wireless communication device can be avoided.

Here, the wireless communication device may further include: an acquisition unit operable to acquire, from the counterpart wireless communication device, a reception acceptance statistic value showing a ratio of the number of communication frames received and demodulated normally by the counterpart wireless communication device with respect to a total number of communication frames, wherein the judgment unit judges whether or not the acquired reception acceptance statistic value is less than a predetermined threshold value, and the transmission unit transmits the training sequence that includes the training symbols greater in number than the predetermined number, when it is judged that the acquired reception acceptance statistic value is less than the predetermined threshold value.

According to the stated structure, when the reception acceptance statistic value showing a ratio of the number of communication frames received and demodulated normally by the counterpart wireless communication device with respect to a total number of communication frames is judged to be less than a predetermined threshold value, the training sequence including a greater number of training symbols than the predetermined number is transmitted, and therefore a reduction in processing performance in the counterpart wireless communication device can be avoided.

Here, the wireless communication device may further include: an acquisition unit operable to acquire, from the counterpart wireless communication device, a training sequence length required by the counterpart wireless communication device when receiving a communication frame, wherein the judgment unit judges whether or not the acquired training sequence length is greater than a predetermined threshold value, and the transmission unit transmits the training sequence that includes the training symbols greater in number than the predetermined number, when it is judged that the acquired training sequence length is greater than the predetermined threshold value.

According to the stated structure, when the training sequence length required by the counterpart wireless communication device when receiving a communication frame is judged to be greater than a predetermined threshold value, the training sequence including a greater number of training symbols than the predetermined number is transmitted, and therefore a reduction in processing performance in the counterpart wireless communication device can be avoided.

Here, the judgment unit may judge whether or not a reception power for a communication frame transmitted from the counterpart wireless communication device is greater than a predetermined threshold value, and the transmission unit may transmit the training sequence that includes the training symbols greater in number than the predetermined number, when it is judged that the reception power is greater than the predetermined threshold value.

According to the stated structure, when the reception strength of the wireless communication device is greater than a predetermined threshold value, the training sequence including a greater number of training symbols than the predetermined number is transmitted, and therefore a reduction in processing performance in the counterpart wireless communication device can be avoided.

Here, the judgment unit may judge whether or not a ratio of the number of communication frames received and demodulated normally by the wireless communication device with respect to a total number of communication frames is less than a threshold value, and the transmission unit may transmit the training sequence that includes the training symbols greater in number than the predetermined number, when it is judged that the ratio is less than the predetermined threshold value.

According to the stated structure, when the ratio of the number of communication frames received and demodulated normally by the wireless communication device with respect to a total number of communication frames is less than a threshold value, the training sequence including a greater number of training symbols than the predetermined number is transmitted, and therefore a reduction in processing performance in the counterpart wireless communication device can be avoided.

Here, the judgment unit may judge whether or not a training sequence length required when receiving a communication frame from the counterpart wireless communication device is greater than a predetermined threshold value, and the transmission unit may transmit the training sequence that includes the training symbols greater in number than the predetermined number, when it is judged that the required training sequence length is greater than the predetermined threshold value.

According to the stated structure, when the training sequence length required when receiving a communication frame from the counterpart wireless communication device is greater than a predetermined threshold value, the training sequence including a greater number of training symbols than the predetermined number is transmitted, and therefore a reduction in processing performance in the counterpart wireless communication device can be avoided.

As has been described, the transmission-side wireless communication device of the present invention increases the length of the training sequence of the transmission frame in order to allocate a training sequence of a sufficient length to AGC, synchronization establishment, AFC and the like, and transmits a communication frame to which the training sequence longer than a predetermined length is attached. The reception-side wireless communication device that receives the communication frame to which the training sequence longer than the predetermined length is attached is able to allocate a sufficiently long training sequence to AGC, synchronization establishment, AFC and the like. Therefore, the present invention has the superior effect of improving communication performance.

### BRIEF DESCRIPTION OF THE DRAWINGS

These and other objects, advantages and features of the invention will become apparent from the following description thereof taken in conjunction with the accompanying drawings which illustrate a specific embodiment of the invention.

In the drawings:

FIG. 1 is a block diagram showing the structure of a wireless communication device 1 of a first embodiment;

FIG. 2 is a block diagram showing the structure of a PHY unit 100;

FIG.3 is a block diagram showing the structure of a training sequence generation unit 102;

FIG. 4A shows an example of the structure of a communication frame 401 that is generated when a maximum repeat times is 10;

FIG. 4B shows an example of the structure of a communication frame 451 that is generated when a maximum repeat times is 15;

FIG. 5 is a block diagram showing the structure of a PHY unit 100a in a wireless communication device 1g of a second embodiment;

FIG. 6 is a block diagram showing the structure of a PHY unit 100b in a wireless communication device 1m of a third embodiment;

FIG. 7 is a block diagram showing the structure of a PHY unit l00c in a wireless communication device 1n of a modification (1) of the third embodiment; and

FIG. 8 is a block diagram showing the structure of a PHY unit l00d in a wireless communication device 1p of a modification (2) of the third embodiment.

### DESCRIPTION OF THE PREFERRED EMBODIMENTS

### 1. First Embodiment

A description is given of a wireless communication device 1 as an embodiment of the present invention with reference to the drawings.

The wireless communication device 1 performs wireless communication with another wireless communication device (hereinafter referred to as a counterpart wireless communication device) according to the IEEE 802.11a standard.

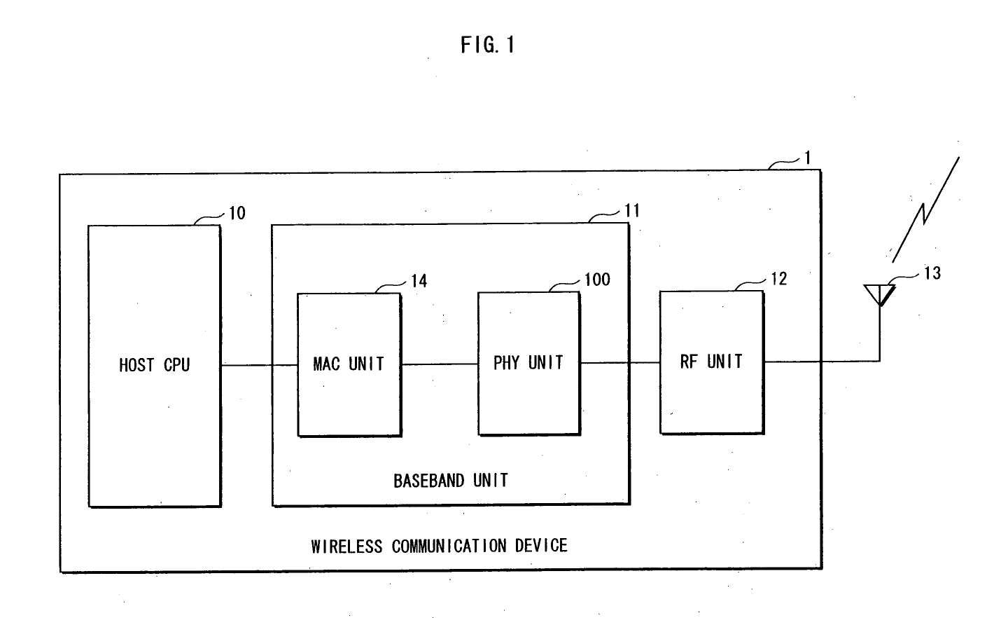

As shown in FIG. 1, the wireless communication device 1 is composed of a host CPU 10 that performs control of the wireless communication device 1 overall; a baseband unit 11; an RF unit 12 that modulates transmission data to a wireless frequency and extracts reception data from a wireless frequency; an antenna 13; and other units that are not illustrated. The baseband unit 11 is composed of a MAC unit 14 and a PHY unit 100.

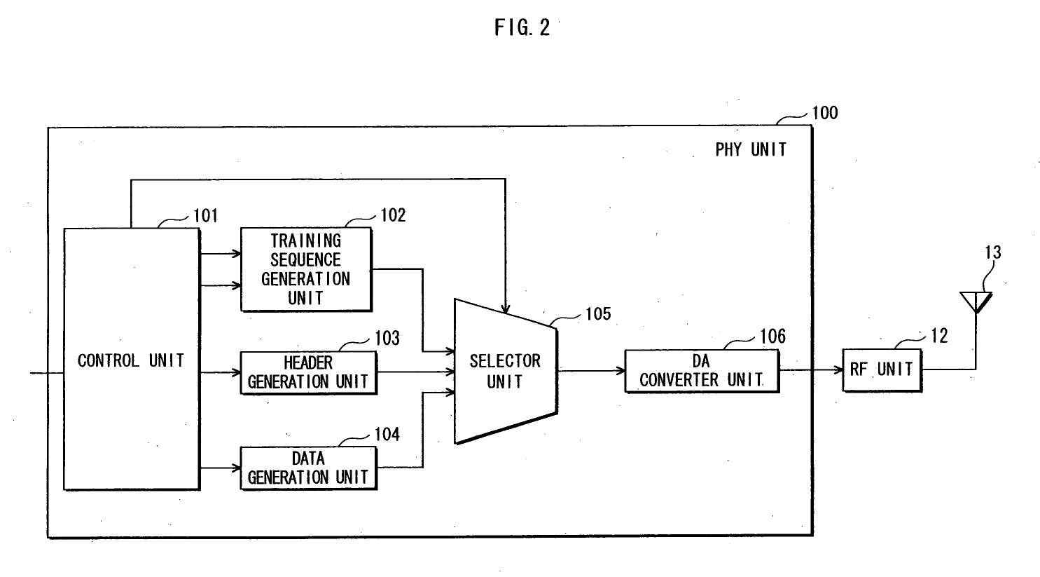

As shown in FIG. 2, the PHY unit 100 is composed of a control unit 101, a training sequence generation unit 102, a header generation unit 103,a data generation unit 104, a selector unit 105, and a DA converter unit 106.

Note that the counterpart wireless communication device has the same structure as the wireless communication device 1.

(1) Control Unit 101

During frame transmission, the control unit 101 first outputs a training sequence generation instruction to the training sequence generation unit 102. The control unit 101 then outputs a header generation instruction to the header generation unit 103 and a data generation instruction to the data generation unit 104.

(2) Training Sequence Generation Unit 102

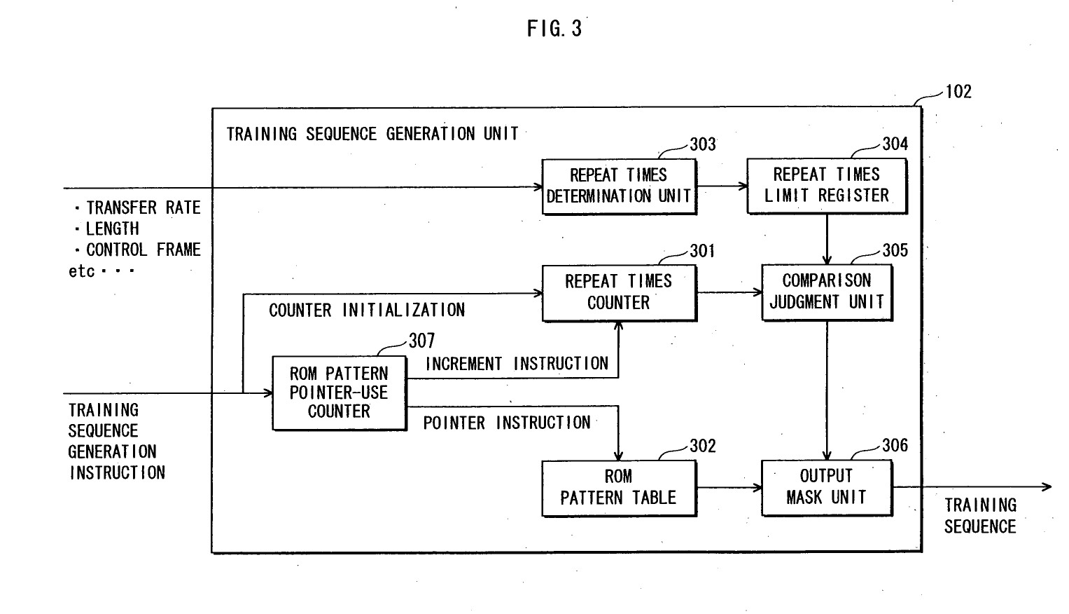

As shown in FIG. 3, the training sequence generation unit 102 is composed of a repeat times counter 301, a ROM pattern table 302, a repeat times determination unit 303, a repeat times limit register 304, a comparison judgment unit 305, an output mask unit 306, and a ROM pattern pointer-use counter 307.

(2-1) ROM Pattern Table 302

The ROM pattern table 302 stores a training symbol (short training symbol) composed of a predetermined plurality of bits. The position of each bit is designated as a pointer.

(2-2) ROM Pattern Pointer-use Counter 307

The ROM pattern pointer-use counter 307 receives a training sequence generation instruction from the control unit 101. Upon receiving the training sequence generation instruction, the ROM pattern pointer-use counter 307 initializes a counter held therein.

(i) Next, the ROM pattern pointer-use counter 307 (a) adds “1” to the counter, and (b) outputs the resultant value of the counter as a pointer to the ROM pattern table 302.

The ROM pattern pointer-use counter 307 then repeats the adding of “1” to the counter (a), and the output of the pointer to the ROM pattern table 302 (b), so as to be performed a number of times equivalent to the number of bits composing the training symbol.

(ii) When the ROM pattern pointer-use counter 307 has finished performing the described (a) and (b) the number of times equivalent to the number of bits composing the training symbol, the ROM pattern pointer-use counter 307 then (c) outputs an increment instruction to the repeat times counter 301.

The ROM pattern pointer-use counter 307 subsequently repeats the described (i) and (ii).

(2-3) Repeat Times Counter 301

The repeat times counter 301 receives a training sequence generation instruction from the control unit 101, and receives an increment instruction from the ROM pattern pointer-use counter 307. The training sequence generation instruction doubles as a counter initialization instruction.

Upon receiving the training sequence generation instruction, in other words the counter initialization instruction, from the control unit 101, the repeat times counter 301 initializes a counter held therein. In other words, the repeat times counter 301 sets the value of the counter to “0”. Furthermore, upon receiving the increment instruction from the ROM pattern pointer-use counter 307, the repeat times counter 301 increments the counter held therein. In other words, the repeat times counter 301 adds “1” to the value of the counter held therein. The repeat times counter 301 outputs the value of the counter held therein to the comparison judgment unit 305.

(2-4) Repeat Times Determination Unit 303

The repeat times determination unit 303 receives a transmission rate, a length, and other information from the control unit 101, and based on the received transmission rate, length and other information, determines a maximum repeat times that shows a maximum number of times that the training symbol is to be output. The repeat times determination unit 303 then writes the determined maximum repeat times to the repeat times limit register 304.

The normal number of maximum repeat times defined by IEEE 802.11a is 10. Here, the maximum repeat times determined by the repeat times determination unit 303 is a value greater than 10, one example being 15.

(2-5) Repeat Times Limit Register 304

The repeat times limit register 304 stores therein a maximum repeat times showing the maximum number of times that the training symbol is to be output.

(2-6) Comparison Judgment Unit 305

The comparison judgment unit 305 compares the maximum repeat times stored in the repeat times limit register 304 with the counter value received from the repeat times counter 301, and when the counter value exceeds the maximum repeat times, outputs a mask instruction to the output mask unit 306. The mask instruction shows that output of the ROM pattern is prohibited. When the counter value does not exceed the maximum repeat times, the comparison judgment unit 305 outputs a permission instruction to the output mask unit 306. The permission instruction shows that output of the ROM pattern is permitted.

(2-7) Output Mask Unit 306

The output mask unit 306 receives the mask instruction or the permission instruction from the comparison judgment unit 305. When the received instruction is the mask instruction, the output mask unit 306 masks output of the ROM pattern from the ROM pattern table 302. When the received instruction is the permission instruction, the output mask unit 306 outputs the ROM pattern from the ROM pattern table 302 to the selector unit 105.

(2) Header Generation Unit 103, Data Generation Unit 104, Selector Unit 105, DA Converter Unit 106

The header generation unit 103 and the data generation unit 104 receive a header generation instruction and a data generation instruction, respectively, from the control unit 101. Under the control of the control unit 101, the header generation unit 103 generates a header and outputs the generated header to the selector unit 105, and the data generation unit 104 generates data and outputs the generated data to the selector unit 105.

Under the control of the control unit 101, the selector unit 105 selects the training sequence, header and data output from the training sequence generation unit 102, the header generation unit 103 and the data generation unit 104, and outputs the selected training sequence, header and data to the DA converter unit 106. In this way, a transmission frame is generated.

The DA converter unit 106 subjects the generated communication frame to DA conversion to convert the communication frame from digital to analog, thereby generating an analog signal.

The generated analog signal is transmitted via the RF unit 12 and the antenna 13.

(3) Exemplary Structure of Generated Communication Frame

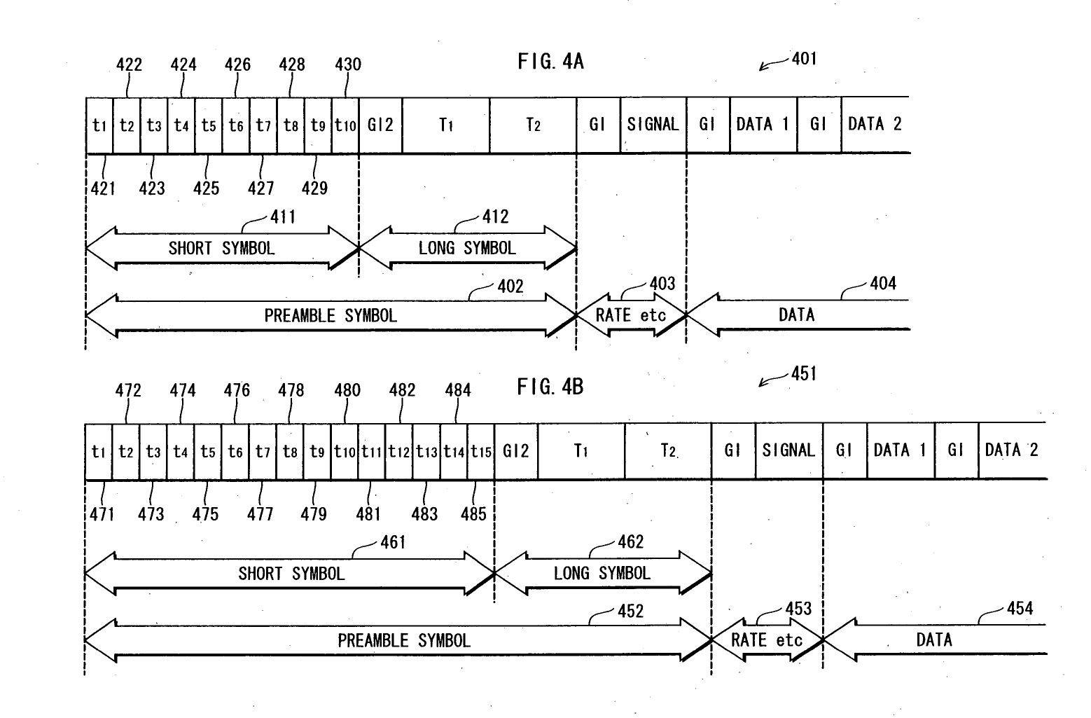

Examples of the structure of the generated communication frames are shown in FIGS. 4A and 4B.

A communication frame 401 shown in FIG. 4A is a communication frame generated in the case of the maximum repeat times stored in the repeat times limit register 304 being 10. A communication frame 451 shown in FIG. 4B is a communication frame generated in the case of the maximum repeat times stored in the repeat times limit register 304 being 15.

The communication frame 401 is composed of a preamble signal 402, a signal 403 including a rate, and data 404. The preamble signal 402 is made up of a short symbol group 411 and a long symbol group 412. The short symbol group 411 includes ten short symbols 421, 422, . . . 430. These short symbols are the described training symbols. The preamble signal 402 as a whole is the described training sequence.

The communication frame 451 is composed of a preamble signal 452, a signal 453 including a rate, and data 454. The preamble signal 452 is made up of a short symbol group 461 and a long symbol group 462. The short symbol group 461 includes ten short symbols 471, 472, . . . 485. These short symbols are the described training symbols. The preamble signal 452 as a whole is the described training sequence.

(4) Conclusion

As has been described, the wireless communication device 1 is capable of outputting a communication frame that has attached thereto a training sequence that is longer than normal. The wireless communication device that receives this communication frame is able to allocate a sufficiently long training sequence to perform processing such as AGC, synchronization establishment and AFC, and therefore high-performance communication can be established.

2. Modification (1) of First Embodiment

A description is given of a wireless communication device 1a (not illustrated) as an example of a modification to the first embodiment.

The modification example wireless communication device 1a has the same structure as the wireless communication device 1 of the first embodiment. The following description focuses on aspects that differ from the wireless communication device 1 of the first embodiment.

The value determined by the repeat times determination unit 303 when the training sequence generation instruction is output from the control unit 101 differs from the wireless communication device 1 of the first embodiment as follows.

When the transmission rate of a frame to be transmitted is less than a certain transfer rate, the normal maximum repeat times is determined, and when the transmission rate of the frame to be transmitted is equal to or greater than a certain transfer rate, an arbitrary maximum repeat times that is greater than the normal maximum repeat times and has been set in advance is determined.

Specifically, the repeat times determination unit 303 receives the transmission rate from the control unit 101, and compares the received transmission rate with a threshold value transmission rate. When the received transmission rate is greater than the threshold value transmission rate, the repeat times determination unit 303 determines a value that is greater than 10, for instance 15, as the maximum repeat times. When the received transmission rate is less than the threshold value transmission rate, the repeat times determination unit 303 determines 10 as the maximum repeat times. Here, 10 is the value defined by IEEE 802.11a.

Next, the repeat times determination unit 303 writes the determined maximum repeat times to the repeat times limit register 304.

It is only when a transmission frame is to be output from the modification example wireless communication device 1a at a certain transmission rate or greater that a training sequence longer than normal is attached. As such, compared to the wireless communication device 1 of the first embodiment, the modification example wireless communication device 1a avoids reduction in communication efficiency caused by attaching redundant training sequence more than necessary. This achieves even higher communication establishment.

Furthermore, the modification example wireless communication device 1a can be used advantageously when sending a large amount of data in order to transmit HV video stream data with a higher quality communication method that employs 16QAM or 64QAM rather than BPSK or QPSK modulation. In such a situation, it is necessary for a transmission unit to estimate a transmission path highly accurately, and therefore the modification example wireless communication device 1a is advantageous due to being able to vary the length of the training sequence depending on the transmission rate.

3. Modification (2) of First Embodiment

A description is given of a wireless communication device 1b (not illustrated) as an example of a modification to the first embodiment.

The modification example wireless communication device 1b has the same structure as the wireless communication device 1 of the first embodiment. The following description focuses on aspects that differ from the wireless communication device 1 of the first embodiment.

The value determined by the repeat times determination unit 303 when the training sequence generation instruction is output from the control unit 101 differs from the wireless communication device 1 of the first embodiment as follows.

When the length of a frame to be transmitted is less than a certain length, the normal maximum repeat times is determined, and when the length of the frame to be transmitted is greater than the certain length, an arbitrary maximum repeat times that is greater than the normal maximum repeat times and has been set in advance is determined.

Specifically, the repeat times determination unit 303 receives the length of the frame to be transmitted from the control unit 101, and compares the received length with a threshold value length. When the received length is greater than the threshold value length, the repeat times determination unit 303 determines a value that is greater than 10, for instance 15, as the maximum repeat times. When the received length is less than the threshold value length, the repeat times determination unit 303 determines 10 as the maximum repeat times. Here, 10 is the value defined by IEEE 802.11a.

Next, the repeat times determination unit 303 writes the determined maximum repeat times to the repeat times limit register 304.

It is only when a transmission frame having a certain length or greater is to be output from the modification example wireless communication device 1b that a training sequence longer than normal is attached. As such, compared to the wireless communication device 1 of the first embodiment, the modification example wireless communication device 1b avoids reduction in communication efficiency caused by attaching redundant training sequence more than necessary. This achieves even higher communication establishment.

Furthermore, when transmitting a frame that is relatively long in length using the wireless communication device 1b, as much as several m seconds of time are spent on frame transmission. The state of the communication path is constantly changing during this period of time of several m seconds, and therefore, in order to deal with changes in the communication path, it is necessary for the reception-side wireless communication device to estimate the transmission path reliably with the training sequence at the head of the frame. As such, the wireless communication device 1b is effective in terms of changing the length of the training sequence in accordance with the frame length.

4. Modification (3) of First Embodiment

A description is given of a wireless communication device 1c (not illustrated) as an example of a modification to the first embodiment.

The modification example wireless communication device 1c has the same structure as the wireless communication device 1 of the first embodiment. The following description focuses on aspects that differ from the wireless communication device 1 of the first embodiment.

The value determined by the repeat times determination unit 303 when the training sequence generation instruction is output from the control unit 101 differs from the wireless communication device 1 of the first embodiment as follows.

When the frame to be transmitted is not a retransmission frame, the normal maximum repeat times is determined, and when the frame to be transmitted is a retransmission frame, an arbitrary maximum repeat times that is greater than the normal maximum repeat times and has been set in advance is determined.

Specifically, the repeat times determination unit 303 receives frame information from the control unit 101. The frame information shows whether or not the frame to be transmitted is a retransmission frame. When the received frame information shows that the frame to be transmitted is a retransmission frame, the repeat times determination unit 303 determines a value that is greater than 10, for instance 15, as the maximum repeat times. When the received frame information shows that the frame to be transmitted is not a retransmission frame, the repeat times determination unit 303 determines 10 as the maximum repeat times. Here, 10 is the value defined by IEEE 802.11a.

It is only when a retransmission frame is to be output from the wireless communication device 1c that a training sequence longer than normal is attached. As such, compared to the wireless communication device 1 of the first embodiment, the modification example wireless communication device 1c avoids reduction in communication efficiency caused by attaching redundant training sequence more than necessary. Furthermore, when performing bandwith compensation to a set level, retransmission processing is the greatest hindrance to bandwidth compensation. Therefore, the efficiency of bandwidth compensation can be improved by using the wireless communication device 1c.

5. Modification (4) of First Embodiment

A description is given of a wireless communication device 1d (not illustrated) as an example of a modification to the first embodiment.

The modification example wireless communication device 1d has the same structure as the wireless communication device 1 of the first embodiment. The following description focuses on aspects that differ from the wireless communication device 1 of the first embodiment.

The value determined by the repeat times determination unit 303 when the training sequence generation instruction is output from the control unit 101 differs from the wireless communication device 1 of the first embodiment as follows.

When the frame to be transmitted is not a control frame such as a beacon frame or an ACK frame, the normal maximum repeat times is determined. When the frame to be transmitted is a control frame, an arbitrary maximum repeat times that is greater than the normal maximum repeat times and has been set in advance is determined.

Specifically, the repeat times determination unit 303 receives frame information from the control unit 101. The frame information shows whether or not the frame to be transmitted is a control frame. When the received frame information shows that the frame to be transmitted is a control frame, the repeat times determination unit 303 determines a value that is greater than 10, for instance 15, as the maximum repeat times. When the received frame information shows that the frame to be transmitted is not a control frame, the repeat times determination unit 303 determines 10 as the maximum repeat times. Here, 10 is the value defined by IEEE 802.11a.

It is only when a control frame is to be output from the wireless communication device ld that a training sequence longer than normal is attached. As such, compared to the wireless communication device 1 of the first embodiment, the modification example wireless communication device id avoids reduction in communication efficiency caused by attaching redundant training sequence more than necessary. This achieves even higher communication establishment. Among representative types of control frames are beacon frames which are used to perform control such as adjusting transmission timing and restoring a terminal from sleep. Transmitting and receiving such control frames with high accuracy also helps to reliably restore the wireless communication device from sleep, and reduce power consumption by the wireless communication device.

6. Modification (5) of First Embodiment

A description is given of a wireless communication device 1e (not illustrated) as an example of a modification to the first embodiment.

The modification example wireless communication device 1e has the same structure as the wireless communication device 1 of the first embodiment. The following description focuses on aspects that differ from the wireless communication device 1 of the first embodiment.

The value determined by the repeat times determination unit 303 when the training sequence generation instruction is output from the control unit 101 differs from the wireless communication device 1 of the first embodiment as follows.

When the frame to be transmitted is not a multicast frame, the normal maximum repeat times is determined. When the frame to be transmitted is a multicast frame, an arbitrary maximum repeat times that is greater than the normal maximum repeat times and has been set in advance is determined.

Specifically, the repeat times determination unit 303 receives frame information from the control unit 101. The frame information shows whether or not the frame to be transmitted is a multicast frame. When the received frame information shows that the frame to be transmitted is a multicast frame, the repeat times determination unit 303 determines a value that is greater than 10, for instance 15, as the maximum repeat times. When the received frame information shows that the frame to be transmitted is not a multicast frame, the repeat times determination unit 303 determines 10 as the maximum repeat times. Here, 10 is the value defined by IEEE 802.11a.

It is only when a multicast frame is to be output from the wireless communication device 1e that a training sequence longer than normal is attached. As such, compared to the wireless communication device 1 of the first embodiment, the modification example wireless communication device 1e avoids reduction in communication efficiency caused by attaching redundant training sequence more than necessary. This achieves even higher communication establishment. Although the effect is not achieved in a peer to peer environment, the possibility of communication breaking down due to multicast failure is reduced in the case of numerous wireless communication devices belonging to a single wireless group, and the communication performance of the system overall is improved.

7. Modification (6) of First Embodiment

A description is given of a wireless communication device 1f (not illustrated) as an example of a modification to the first embodiment.

The modification example wireless communication device 1f has the same structure as the wireless communication device 1 of the first embodiment. The following description focuses on aspects that differ from the wireless communication device 1 of the first embodiment.

The value determined by the repeat times determination unit 303 when the training sequence generation instruction is output from the control unit 101 differs from the wireless communication device 1 of the first embodiment as follows.

When the counterpart wireless communication device to which a frame is to be transmitted is not a terminal that performs bandwidth compensation, the normal maximum repeat times is determined. When the counterpart wireless communication device is a terminal that performs bandwidth compensation, an arbitrary maximum repeat times that is greater than the normal maximum repeat times and has been set in advance is determined.

Specifically, the repeat times determination unit 303 receives terminal information from the control unit 101. The terminal information shows whether or not the counterpart wireless communication device is a terminal that performs bandwidth compensation. When the received terminal information shows that the counterpart wireless communication device is a terminal performs bandwidth compensation, the repeat times determination unit 303 determines a value that is greater than 10, for instance 15, as the maximum repeat times. When the received terminal information shows that the counterpart wireless communication device is not a terminal that performs bandwidth compensation, the repeat times determination unit 303 determines 10 as the maximum repeat times. Here, 10 is the value defined by IEEE 802.11a.

It is only when a transmission frame is to be sent to a terminal that performs bandwidth compensation from the wireless communication device if that a training sequence longer than normal is attached. As such, compared to the wireless communication device 1 of the first embodiment, the modification example wireless communication device if avoids reduction in communication efficiency caused by attaching redundant training sequence more than necessary. This achieves even higher communication establishment.

### 8. Second Embodiment

A description is given of a wireless communication device 1g (not illustrated) as another embodiment of the present invention.

As with the wireless communication device 1, the wireless communication device 1g performs wireless communication with a counterpart wireless communication device according to the IEEE 802.1a standard.

Similarly to the wireless communication device 1, the wireless communication device 1 is composed of a host CPU 10, a baseband unit 11, an RF unit 12, an antenna 13, and other units that are not illustrated. The baseband unit 11 is composed of a MAC unit 14 and a PHY unit 100a.

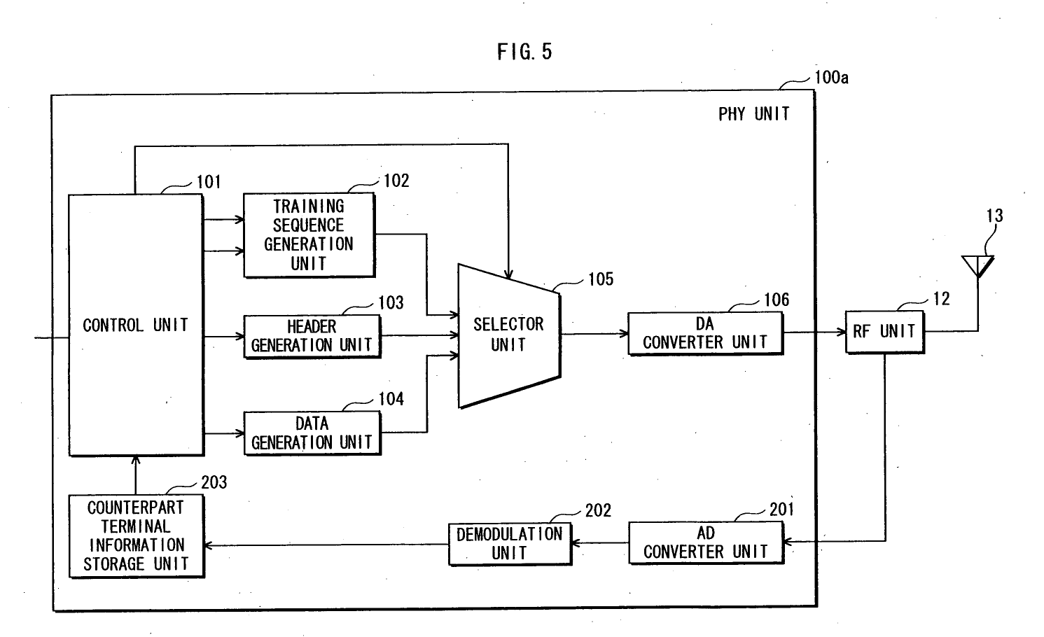

As shown in FIG. 5, the PHY unit 100 is composed of a control unit 101, a training sequence generation unit 102, a header generation unit 103, a data generation unit 104, a selector unit 105, a DA converter unit 106, an AD converter unit 201, a demodulation unit 202 and a counterpart terminal information storage unit 203.

The wireless communication device 1g differs from the wireless communication device 1 in that the baseband unit 11 has the PHY unit 100a instead of the PHY unit 100, and the PHY unit 100a has the AD converter unit 201, the demodulation unit 202 and the counterpart terminal information storage unit 203 in addition to the elements of the PHY unit 100.

The AD converter unit 201 converts a reception signal that has been received via the antenna 13 and the RF unit 12 from an analog signal into a digital signal, and then the demodulation unit 202 demodulates the digital signal, thereby generating digital information. The generated digital information includes information showing the signal detection method of used by the counterpart wireless communication device. The demodulation unit 202 writes the received signal detection method information to the counterpart terminal information storage unit 203. The wireless communication device 1g receives the signal detection method information as terminal information of the counterpart wireless communication device before transmission of a communication frame.

The value determined by the repeat times determination unit 303 when the training sequence generation instruction is output from the control unit 101 differs from the wireless communication device 1 of the first embodiment as follows.

The repeat times determination unit 303 reads the signal detection method information of the counterpart wireless communication device stored in the other terminal information storage unit 203, and when the read signal detection method information shows that the counterpart wireless communication device does not employ a signal detection method that uses pattern matching, the normal maximum repeat times is determined. When the read signal detection method information shows that the counterpart wireless communication device employs a signal detection method that uses pattern matching, an arbitrary maximum repeat times that is greater than the normal maximum repeat times and has been set in advance is determined.

Specifically, the control unit 101 reads the signal detection method information from the counterpart terminal information storage unit 203, and outputs the read signal detection method information to the repeat times determination unit 303. The repeat times determination unit 303 receives the signal detection method information from the control unit 101, and when the received signal detection method information shows that the counterpart wireless communication device employs a signal detection method that uses pattern matching, the repeat times determination unit 303 determines a value that is greater than 10, for instance 15, as the maximum repeat times. When the received signal detection method information shows that the counterpart wireless communication device does not employ a signal detection method that uses pattern matching, the repeat times determination unit 303 determines 10 as the maximum repeat times. Here, 10 is the value defined by IEEE 802.11a.

It is only when sending a frame from the wireless communication device 1g to a wireless communication device that performs signal detection using pattern matching that a training sequence longer than normal attached. As such, compared to the wireless communication device 1 of the first embodiment, the wireless communication device 1g avoids reduction in communication efficiency caused by attaching redundant training sequence more than necessary. This achieves even higher communication establishment.

9. Modification (1) of Second Embodiment

A description is given of a wireless communication device 1h (not illustrated) as an example of a modification to the second embodiment.

The modification example wireless communication device 1h has the same structure as the wireless communication device 1g of the second embodiment. The following description focuses on aspects that differ from the wireless communication device 1g of the second embodiment.

A difference is that in the wireless communication device 1h, digital information that is generated as a result of receiving via the antenna 12 and RF unit 13, AD converting by the AD converter unit 201, and demodulating by the demodulation unit 202 includes antenna method information showing whether or not the counterpart wireless communication device employs an antenna diversity method, in other words, whether or not the counterpart wireless communication device has a communication unit that uses an antenna diversity method. The antenna method information is written to the counterpart terminal information storage unit 203.

In addition, the value determined by the repeat times determination unit 303 when the training sequence generation instruction is output from the control unit 101 differs from the wireless communication device 1g of the second embodiment as follows.

When the antenna method information stored in the counterpart terminal information storage unit 203 does not show an antenna diversity method, the normal maximum repeat times is determined, and when the antenna method information shows an antenna diversity method, an arbitrary maximum repeat times that is greater than the normal maximum repeat times and has been set in advance is determined.

Specifically, the control unit 101 reads the antenna method information from the counterpart terminal information storage unit 203, and outputs the read antenna method information to the repeat times determination unit 303. The repeat times determination unit 303 receives the antenna method information from the control unit 101, and when the received antenna method information shows that the counterpart wireless communication device employs an antenna diversity method, the repeat times determination unit 303 determines a value that is greater than 10, for instance 15, as the maximum repeat times. When the received antenna method information shows that the counterpart wireless communication device does not employ an antenna diversity method, the repeat times determination unit 303 determines 10 as the maximum repeat times. Here, 10 is the value defined by IEEE 802.11a.

It is only when sending a transmission frame from the wireless communication device 1h to a terminal that employs an antenna diversity method that a training sequence longer than a normal training sequence is attached. As such, compared to the wireless communication device 1 of the first embodiment, the wireless communication device 1h avoids reduction in communication efficiency caused by attaching redundant training sequence more than necessary. This achieves even higher communication establishment.

10. Modification (2) of Second Embodiment

A description is given of a wireless communication device 1i (not illustrated) as an example of a modification to the second embodiment.

The modification example wireless communication device 1i has the same structure as the wireless communication device 1g of the second embodiment. The following description focuses on aspects that differ from the wireless communication device 1g of the second embodiment.

A difference is that in the wireless communication device 1i, digital information that is generated as a result of receiving via the antenna 12 and RF unit 13, AD converting by the AD converter unit 201, and demodulating by the demodulation unit 202 includes reception power information showing the reception power of the counterpart wireless communication device. The reception power information shows reception power of the counterpart wireless communication device when receiving a communication frame transmitted by the wireless communication device 1i. The reception power information is written to the other party information storage unit 203. In this way, the wireless communication device 1i receives the reception power information showing the reception power of the counterpart wireless communication device in advance as counterpart terminal information.

In addition, the value determined by the repeat times determination unit 303 when the training sequence generation instruction is output from the control unit 101 differs from the wireless communication device 1g of the second embodiment as follows.

The repeat times determination unit 303 checks the reception power information of the counterpart wireless communication device stored in the counterpart terminal information storage unit 203, and when the reception power of the counterpart wireless communication device is less than or equal to a certain level, the normal maximum repeat times is determined. When the reception power of the counterpart wireless communication device is greater than the certain level, an arbitrary maximum repeat times that is greater than the normal maximum repeat times and has been set in advance is determined.

Specifically, the control unit 101 reads the reception power information from the counterpart terminal information storage unit 203, and outputs the read reception power information to the repeat times determination unit 303. The repeat times determination unit 303 receives the reception power information from the control unit 101, and when the received reception power information shows that the reception power is greater than a certain level, the repeat times determination unit 303 determines a value that is greater than 10, for instance 15, as the maximum repeat times. When the received reception power information shows that the reception power is less than or equal to the certain level, the repeat times determination unit 303 determines 10 as the maximum repeat times. Here, 10 is the value defined by IEEE 802.11a.

It is only when a transmission frame is to be sent from the modification example wireless communication device 1i to a wireless communication device that receives power greater than a certain level that a training sequence longer than normal is attached. As such, compared to the wireless communication device 1 of the first embodiment, the modification example wireless communication device 11 avoids reduction in communication efficiency caused by attaching redundant training sequence more than necessary. This achieves even higher communication establishment.

11. Modification (3) of Second Embodiment

A description is given of a wireless communication device 1j (not illustrated) as an example of a modification to the second embodiment.

The modification example wireless communication device 1j has the same structure as the wireless communication device 1g of the second embodiment. The following description focuses on aspects that differ from the wireless communication device 1g of the second embodiment.

A difference is that in the wireless communication device 1j, digital information that is generated as a result of receiving via the antenna 12 and RF unit 13, AD converting by the AD converter unit 201, and demodulating by the demodulation unit 202 includes statistic information of the counterpart wireless communication device. This statistic information is collected by the counterpart wireless communication device when the wireless communication device 1j transmits a communication frame to the counterpart wireless communication device, and is a an acceptance result showing a ratio of the number of normally received and demodulated communication frames with respect to a total number of communication frames. The statistic information is written to the counterpart terminal information storage unit 203. In this way, the wireless communication device 1j receives statistic information of the counterpart wireless communication device in advance as counterpart terminal information.

In addition, the value determined by the repeat times determination unit 303 when the training sequence generation instruction is output from the control unit 101 differs from the wireless communication device 1g of the second embodiment as follows.

The repeat times determination unit 303 checks the statistic information of the counterpart wireless communication device stored in the counterpart terminal information storage unit 203, and when the value shown by the statistic information is greater than a certain level, the normal maximum repeat times is determined. When the value shown by the statistic information is less than or equal to the certain level, an arbitrary maximum repeat times that is greater than the normal maximum repeat times and has been set in advance is determined.

Specifically, the control unit 101 reads the statistic information from the counterpart terminal information storage unit 203, and outputs the read statistic information to the repeat times determination unit 303. The repeat times determination unit 303 receives the statistic information from the control unit 101, and when the value shown by the received statistic is less than or equal to a certain level, the repeat times determination unit 303 determines a value that is greater than 10, for instance 15, as the maximum repeat times. When the value shown by the received statistic information is greater than the certain level, the repeat times determination unit 303 determines 10 as the maximum repeat times. Here, 10 is the value defined by IEEE 802.11a.

It is only when a transmission frame is to be sent from the modification example wireless communication device 1j to a wireless communication device whose statistic information shows a value less than a certain level that a training sequence longer than normal is attached. As such, compared to the wireless communication device 1 of the first embodiment, the wireless communication device 1j avoids reduction in communication efficiency caused by attaching redundant training sequence more than necessary. This achieves even higher communication establishment.

12. Modification (4) of Second Embodiment

A description is given of a wireless communication device 1k (not illustrated) as an example of a modification to the second embodiment.

The modification example wireless communication device 1k has the same structure as the wireless communication device 1g of the second embodiment. The following description focuses on aspects that differ from the wireless communication device 1g of the second embodiment.

A difference is that in the wireless communication device 1k, digital information that is generated as a result of receiving via the antenna 12 and RF unit 13, AD converting by the AD converter unit 201, and demodulating by the demodulation unit 202 includes a training sequence length of the training sequence of the counterpart wireless communication device. The training sequence length shows the length of the training sequence that was necessary when the counterpart wireless communication device received a communication frame from the wireless communication device 1k. The training sequence length is written to the other part information storage unit 203. In this way, the wireless communication device 1k receives the training sequence length of the counterpart wireless communication device in advance as counterpart terminal information.

In addition, the value determined by the repeat times determination unit 303 when the training sequence generation instruction is output from the control unit 101 differs from the wireless communication device 1g of the second embodiment as follows.

The repeat times determination unit 303 checks the training sequence length of the counterpart wireless communication device stored in the counterpart terminal information storage unit 203, and when the training sequence length is less than or equal to a certain level, the normal maximum repeat times is determined. When the training sequence length is greater than the certain level, an arbitrary maximum repeat times that is greater than the normal maximum repeat times and has been set in advance is determined.

Specifically, the control unit 101 reads the training sequence length from the counterpart terminal information storage unit 203, and outputs the read training sequence length to the repeat times determination unit 303. The repeat times determination unit 303 receives the training sequence length from the control unit 101, and when the training sequence length is greater than a certain length, the repeat times determination unit 303 determines a value that is greater than 10, for instance 15, as the maximum repeat times. When the length shown by received training sequence length is less than or equal to the certain length, the repeat times determination unit 303 determines 10 as the maximum repeat times. Here, 10 is the value defined by IEEE 802.11a.

It is only when a transmission frame is to be output from the wireless communication device 1k to a counterpart wireless communication device that requires a training sequence longer than a certain length at the time of reception that a training sequence longer than normal is attached. As such, compared to the wireless communication device 1 of the first embodiment, the wireless communication device 1k avoids reduction in communication efficiency caused by attaching redundant training sequence more than necessary. This achieves even higher communication establishment.

### 13. Third Embodiment

A description is given of a wireless communication device 1m (not illustrated) as yet another embodiment of the present invention.

As with the wireless communication device 1g, the wireless communication device 1m performs wireless communication with a counterpart wireless communication device according to the IEEE 802.11a standard.

Similarly to the wireless communication device 1g, the wireless communication device 1 is composed of a host CPU 10, a baseband unit 11, an RF unit 12, an antenna 13, and other units. The baseband unit 11 is composed of a MAC unit 14 and a PHY unit 100b.

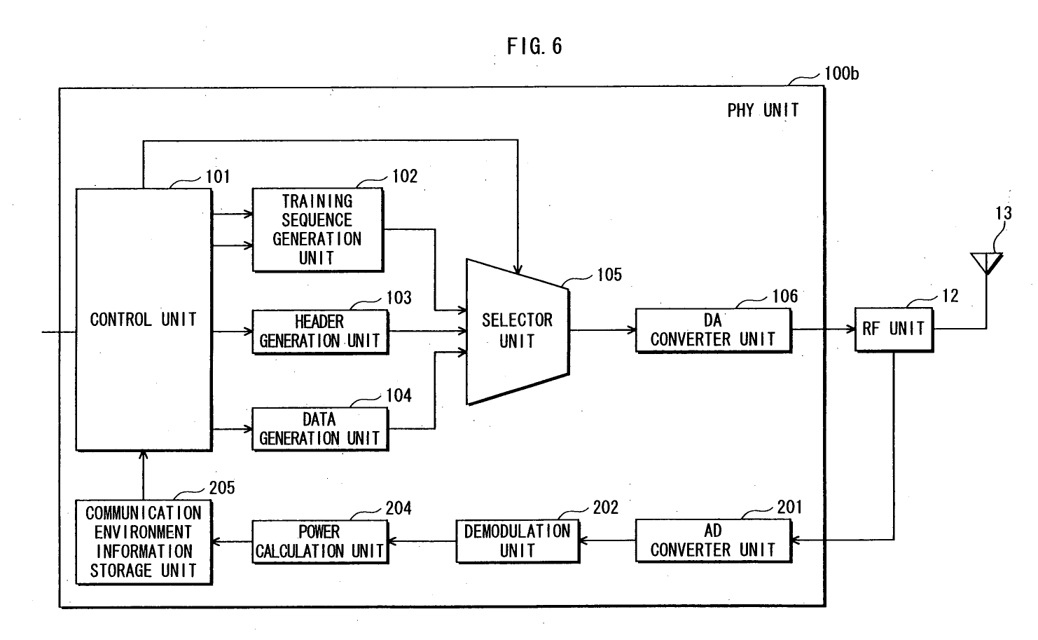

As shown in FIG. 6, the PHY unit 100b is composed of a control unit 101, a training sequence generation unit 102, a header generation unit 103, a data generation unit 104, a selector unit 105, a DA converter unit 106, an AD converter unit 201, a demodulation unit 202, a power calculation unit 204, and a communication environment information storage unit 205.

The wireless communication device 1m differs from the wireless communication device 1g in that the baseband unit 11 has the PHY unit 100b instead of the PHY unit 100a, and the PHY unit 100b has the power calculation unit 204 and the communication environment information storage unit 205 instead of the counterpart terminal information storage unit 203.

In the second embodiment, the wireless communication device 1g uses counterpart terminal information obtained by the counterpart wireless communication device when receiving a frame from the wireless communication device 1g to determine the length of the training sequence to be used when transmitting a frame. However, in the third embodiment, the wireless communication device 1m determines the length of the training sequence based on communication environment information obtained by the wireless communication device 1m when receiving a frame from a counterpart wireless communication device.

The AD converter unit 201 AD converts a reception signal that has been received via the antenna 13 and the RF unit 12 from an analog signal into a digital signal, and then the demodulation unit 202 demodulates the digital signal, thereby generating demodulated information. The power calculation unit 204, calculates reception power with use of the generated demodulated information, and writes the calculated reception power to the communication environment information storage unit 205 as communication environment information.

The value determined by the repeat times determination unit 303 when the training sequence generation instruction is output from the control unit 101 differs from the wireless communication device 1g of the second embodiment as follows.

The repeat times determination unit 303 checks the reception power of the wireless communication device 1m stored in the communication environment information storage unit 205, and when the value of the reception power is less than or equal to a certain level, the normal maximum repeat times is determined. When the value of the reception power is greater than the certain level, an arbitrary maximum repeat times that is greater than the normal maximum repeat times and has been set in advance is determined.

Specifically, the control unit 101 reads the communication environment information from the communication environment information storage unit 205, and outputs the read communication environment information to the repeat times determination unit 303. The repeat times determination unit 303 receives the communication environment information from the control unit 101, and when the reception power shown by the received communication environment information is greater than a certain level, the repeat times determination unit 303 determines a value that is greater than 10, for instance 15, as the maximum repeat times. When the reception power shown by the received communication environment information is less than or equal to the certain level, the repeat times determination unit 303 determines 10 as the maximum repeat times. Here, 10 is the value defined by IEEE 802.11a.

It is only in the case of a signal being received with a reception power greater than a certain level from the counterpart wireless communication device that the wireless communication device 1m attaches a training sequence longer than normal when transmitting a transmission frame to the counterpart wireless communication device.

As such, compared to the wireless communication device 1 of the first embodiment, the wireless communication device 1m avoids reduction in communication efficiency caused by attaching redundant training sequence more than necessary. This achieves even higher communication establishment.

14. Modification (1) of Third Embodiment

A description is given of a wireless communication device 1n (not illustrated) as an example of a modification to the third embodiment.

The modification example wireless communication device 1n has similar structure to the wireless communication device 1m of the third embodiment. The following description focuses on aspects that differ from the wireless communication device 1m of the third embodiment.

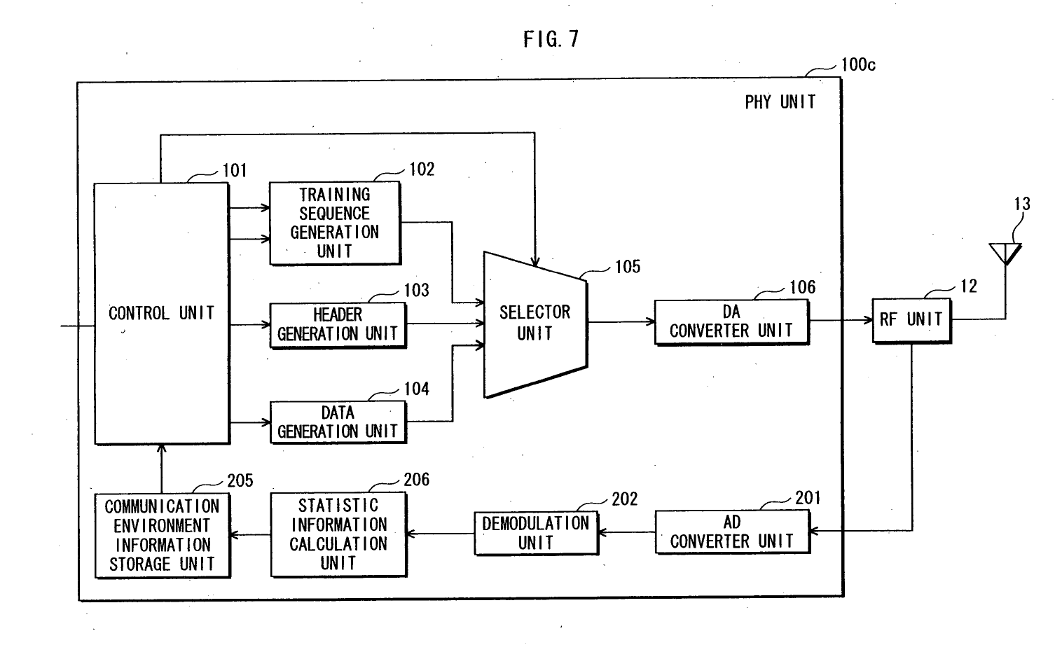

The wireless communication device 1n differs from the wireless communication device 1m in that the baseband unit 11 has the PHY unit 100c as shown in FIG. 7 instead of the PHY unit 100b, and the PHY unit 100c has a statistic information calculation 206 instead of the power calculation unit 204 of the PHY unit 100b.

The demodulation unit 202 outputs the generated demodulated information to the statistic information calculation unit 206, and the statistic information calculation unit 206 receives the generated demodulated information from the demodulation unit 202. Using the received demodulation information, the statistic information calculation unit 206 calculates statistic information that is communication acceptance showing a ratio of communication frames normally received and demodulated with respect to all communication frames received from the counterpart wireless communication device. The statistic information calculation unit 206 writes the calculated statistic information to the communication environment information storage unit 205.

In addition, the value determined by the repeat times determination unit 303 when the training sequence generation instruction is output from the control unit 101 differs from the wireless communication device 1m of the third embodiment as follows.

The repeat times determination unit 303 checks the statistic information that is the reception acceptance of communication received by the wireless communication device 1n stored in the communication environment information storage unit 205, and when the value shown by the statistic information is greater than a certain level, the normal maximum repeat times is determined. When the value shown by the statistic information is less than or equal to the certain level, an arbitrary maximum repeat times that is greater than the normal maximum repeat times and has been set in advance is determined.

Specifically, the control unit 101 reads the statistic information of the reception acceptance that is the communication environment information from the communication environment storage unit 205, and outputs the read statistic information to the repeat times determination unit 303. The repeat times determination unit 303 receives the statistic information from the control unit 101, and when the value shown by the statistic information is less than or equal to a certain level, the repeat times determination unit 303 determines a value that is greater than 10, for instance 15, as the maximum repeat times. When the value shown by the received statistic information is greater than the certain level, the repeat times determination unit 303 determines 10 as the maximum repeat times. Here, 10 is the value defined by IEEE 802.11a.

It is only in the case of the value of the reception acceptance statistic information being less than a certain level that the wireless communication device 1n attaches a training sequence longer than normal when transmitting a transmission frame to a counterpart wireless communication device. As such, compared to the wireless communication device 1 of the first embodiment, the modification example wireless communication device 1n avoids reduction in communication efficiency caused by attaching redundant training sequence more than necessary. This achieves even higher communication establishment.

15. Modification (2) of Third Embodiment

A description is given of a wireless communication device 1p (not illustrated) as an example of a modification to the third embodiment.

The modification example wireless communication device 1p has similar structure to the wireless communication device 1m of the third embodiment. The following description focuses on aspects that differ from the wireless communication device 1m of the third embodiment.

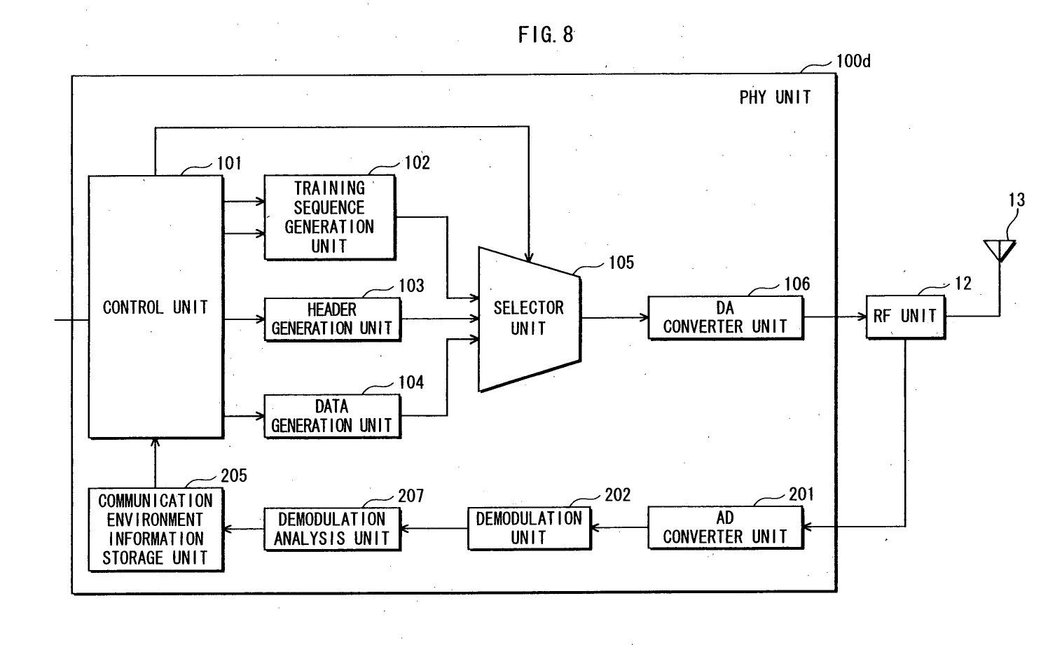

The wireless communication device 1p differs from the wireless communication device 1m in that the baseband unit 11 has the PHY unit 100d as shown in FIG. 8 instead of the PHY unit 100b, and the PHY unit 100d has a demodulation analysis unit 207 instead of the power calculation unit 204 of the PHY unit

The demodulation unit 202 outputs the generated. demodulation information to the demodulation analysis unit 207, and the demodulation analysis unit 207 receives the generated demodulation information. The demodulation analysis unit 207 generates a training sequence length required when the wireless communication device 1p receives a frame from a counterpart wireless communication device, and writes the generated training sequence length to the communication environment information storage unit 205 as communication environment information.

In addition, the value determined by the repeat times determination unit 303 when the training sequence generation instruction is output from the control unit 101 differs from the wireless communication device 1m of the third embodiment as follows.

The repeat times determination unit 303 checks the training sequence length required at reception by the wireless communication device 1p stored in the communication environment information storage unit 205, and when the value of the required training sequence length is less than or equal to a certain value, the normal maximum repeat times is determined. When the value of the required training sequence length is greater than the certain value, an arbitrary maximum repeat times that is greater than the normal maximum repeat times and has been set in advance is determined.

Specifically, the control unit 101 reads the communication environment information that is the training sequence length from the communication environment information storage unit 205, and outputs the read training sequence length information to the repeat times determination unit 303. The repeat times determination unit 303 receives the training sequence length from the control unit 101, and when the training sequence length is greater than a certain level, the repeat times determination unit 303 determines a value that is greater than 10, for instance 15, as the maximum repeat times. When the training sequence length shown by the received training sequence length information is less than or equal to the certain level, the repeat times determination unit 303 determines 10 as the maximum repeat times. Here, 10 is the value defined by IEEE 802.11a.

It is only in the case of the repeat times of the training sequence necessary when receiving being greater than a certain level that the wireless communication device 1p attaches a training sequence longer than normal to the transmission frame when transmitting a transmission frame to the counterpart wireless communication device. As such, compared to the wireless communication device 1 of the first embodiment, the wireless communication device 1p avoids reduction in communication efficiency caused by attaching redundant training sequence more than necessary. This achieves even higher communication establishment.

### INDUSTRIAL APPLICABILITY

The wireless communication device of the present invention is capable of realizing high performance communication, and is widely applicable to wireless communication modules. Furthermore, the wireless communication device of the present invention can be used for managerially, in other words, repeatedly and continuously, in an industry in which various communications are performed. The wireless communication device of the present invention can also be used managerially, in other words, repeatedly and continuously, in an electronic device manufacturing industry in which the wireless communication device is manufactured and sold.

Although the present invention has been fully described by way of examples with reference to the accompanying drawings, it is to be noted that various changes and modification will be apparent to those skilled in the art. Therefore, unless otherwise such changes and modifications depart from the scope of the present invention, they should be construed as being included therein.

What is claimed is:

1. A wireless communication device that performs wireless communication with a counterpart wireless communication device, characterized by:
transmitting, attached to a communication frame, a training sequence that includes training symbols of a fixed pattern, the training symbols being greater in number than a predetermined number as necessary.

2. The wireless communication device of claim 1, comprising:
a judgment unit operable to judge whether or not to make a length of the training sequence longer than a normal training sequence length; and
a transmission unit operable to, when it is judged that that the length of the training sequence is to be made longer than the normal training sequence length, transmit the training sequence that includes the training symbols greater in number than the predetermined number.

3. The wireless communication device of claim 2, wherein
the judgment unit judges whether or not a transmission rate is greater than a predetermined threshold value, and p1 the transmission unit transmits the training sequence that includes the training symbols greater in number than the predetermined number, when it is judged that the transmission rate is greater than the predetermined threshold value.

4. The wireless communication device of claim 2, wherein
the judgment unit judges whether or not a data length of a communication frame is greater than a predetermined threshold value, and
the transmission unit transmits the training sequence that includes the training symbols greater in number than the predetermined number, when it is judged that the data length of the communication frame is greater than the predetermined threshold value.

5. The wireless communication device of claim 2, wherein
the judgment unit judges whether or not a communication frame is a retransmission frame, and
the transmission unit transmits the training sequence that includes the training symbols greater in number than the predetermined number, when it is judged that the communication frame is a retransmission frame.

6. The wireless communication device of claim 2, wherein
the judgment unit judges whether or not a communication frame is a control frame pertaining to communication control, and
the transmission unit transmits the training sequence that includes the training symbols greater in number than the predetermined number, when it is judged that the communication frame is a control frame.

7. The wireless communication device of claim 2, wherein
the judgment unit judges whether or not a communication frame is a multicast frame, and
the transmission unit transmits the training sequence that includes the training symbols greater in number than the predetermined number, when it is judged that the communication frame is a multicast frame.

8. The wireless communication device of claim 2, wherein
the judgment unit judges whether or not the counterpart wireless communication device performs bandwidth compensation, and
the transmission unit transmits the training sequence that includes the training symbols greater in number than the predetermined number, when it is judged that the counterpart wireless communication device performs bandwidth compensation.

9. The wireless communication device of claim 2, wherein
the judgment unit judges whether or not the counterpart wireless communication device performs signal detection using a certain signal detection method, and
the transmission unit transmits the training sequence that includes the training symbols greater in number than the predetermined number, when it is judged that the counterpart wireless communication device performs signal detection using the signal detection method.

10. The wireless communication device of claim 2, further comprising:
an acquisition unit operable to acquire, from the counterpart wireless communication device, antenna method information showing whether or not the counterpart wireless communication device has a communication unit that uses an antenna diversity method, wherein
the judgment unit judges, with use of the acquired antenna method information, whether or not the counterpart wireless communication device has a communication unit that uses an antenna diversity method, and
the transmission unit transmits the training sequence that includes the training symbols greater in number than the predetermined number, when it is judged that the counterpart wireless communication device has a communication unit that uses an antenna diversity method.

11. The wireless communication device of claim 2, further comprising:
an acquisition unit operable to acquire, from the counterpart wireless communication device, reception power. information showing reception power of the counterpart wireless communication device, wherein
the judgment unit judges whether or not the reception power shown by the acquired reception power information is greater than a predetermined threshold value, and
the transmission unit transmits the training sequence that includes the training symbols greater in number than the predetermined number, when it is judged that the reception power is greater than the predetermined threshold value.

12. The wireless communication device of claim 2, further comprising:
an acquisition unit operable to acquire, from the counterpart wireless communication device, a reception acceptance statistic value showing a ratio of the number of communication frames received and demodulated normally by the counterpart wireless communication device with respect to a total number of communication frames, wherein
the judgment unit judges whether or not the acquired reception acceptance statistic value is less than a predetermined threshold value, and
the transmission unit transmits the training sequence that includes the training symbols greater in number than the predetermined number, when it is judged that the acquired reception acceptance statistic value is less than the predetermined threshold value.

13. The wireless communication device of claim 2, further comprising:
an acquisition unit operable to acquire, from the counterpart wireless communication device, a training sequence length required by the counterpart wireless communication device when receiving a communication frame, wherein
the judgment unit judges whether or not the acquired training sequence length is greater than a predetermined threshold value, and
the transmission unit transmits the training sequence that includes the training symbols greater in number than the predetermined number, when it is judged that the acquired training sequence length is greater than the predetermined threshold value.

14. The wireless communication device of claim 2, wherein
the judgment unit judges whether or not a reception power for a communication frame transmitted from the counterpart wireless communication device is greater than a predetermined threshold value, and
the transmission unit transmits the training sequence that includes the training symbols greater in number than the predetermined number, when it is judged that the reception power is greater than the predetermined threshold value.

15. The wireless communication device of claim 2, wherein
the judgment unit judges whether or not a ratio of the number of communication frames received and demodulated normally by the wireless communication device with respect to a total number of communication frames is less than a threshold value, and
the transmission unit transmits the training sequence that includes the training symbols greater in number than the predetermined number, when it is judged that the ratio is less than the predetermined threshold value.

16. The wireless communication device of claim 2, wherein
the judgment unit judges whether or not a training sequence length required when receiving a communication frame from the counterpart wireless communication device is greater than a predetermined threshold value, and
the transmission unit transmits the training sequence that includes the training symbols greater in number than the predetermined number, when it is judged that the required training sequence length is greater than the predetermined. threshold value.
